(19) United States
(12) Patent Application Publication
(10) Pub. No.: US 2026/0212669 A1
(43) Pub. Date: Jul. 23, 2026

(54) SELECTION APPARATUS, SELECTION METHOD, AND RECORDING MEDIUM

(71) Applicant: KAGOME CO., LTD., Tokyo (JP)

(72) Inventor: Tami KOBAYASHI, Tokyo (JP)

(73) Assignee: KAGOME CO., LTD., Tokyo (JP)

(21) Appl. No.: 19/451,903

(22) Filed: Jan. 16, 2026

(30) Foreign Application Priority Data
Jan. 20, 2025 (JP) 2025-007357

(51) Int. Cl. G06V 20/10; G06V 20/13

(52) U.S. Cl. CPC G06V 20/188; G06V 20/13

(57) ABSTRACT

In this selection apparatus, an acquisition unit acquires field condition information that indicates respective field conditions related to crop cultivation at a plurality of points in a field subject to survey. A selection unit uses information regarding the field conditions that are obtained from the acquired field condition information, a plurality of points that satisfy a point selection requirement which is given to the field subject to survey in advance. A determination unit determines, from among the plurality of points selected, sampling points at which a sampling survey is actually conducted. An output unit outputs selection information and determination information, the selection information indicating selected points which are appropriate for sampling, the determination information indicating the sampling points at which the sampling survey is actually conducted.

### CROSS-REFERENCE TO RELATED APPLICATIONS

This application claims priority to Japanese Patent Application No. 2025-007357, filed Jan. 20, 2025, the entire contents of which are hereby incorporated by reference.

### TECHNICAL FIELD

The present disclosure relates to a selection apparatus, a selection method, and a recording medium that are associated with a field survey.

### BACKGROUND

Cultivators who cultivate crops in fields and managers of the fields (hereinafter also referred to as “field operators”) can actually observe the fields to survey field conditions, including a crop growth status.

Patent Literature 1 (International Publication No. 2016/178268) discloses using a sensing robot disposed at a position such as a road within an area subject to management, to check for the presence or absence of pests in a field.

### CITATION LIST

### Patent Literature

Patent Literature 1

International Publication No. WO 2016/178268

### SUMMARY

### Technical Problem

However, for the reason that a burden on field operators is heavy due to the vastness of a field and the reason that there are time constraints, it can be difficult for the field operators to actually patrol the entire field and survey the condition of the entire field. In such cases, for example, points at which field conditions are surveyed may be determined as sampling points in the field, and field conditions such as crop growth statuses at the sampling points are surveyed. On the basis of the result of the survey, the condition of the entire field is estimated. The determination of the sampling points is, for example, based on the intuition and experience of the field operators. In such determination of the sampling points based on intuition and experience, it is difficult for field operators with little experience to determine appropriate sampling points due to lack of experience. If the sampling points are not appropriate, when the condition of the entire field is estimated using the survey results at such sampling points, there is a concern that the probability that the estimation result will deviate from the actual condition of the entire field could increase. Such a situation leads to a problem of causing inconveniences in processes in which, for example, with use of the information regarding the condition of the entire field, a crop yield is estimated and a harvest time is predicted.

The present disclosure has been devised for solving the problem as described above. Specifically, the main object of the present disclosure is to provide a selection apparatus, a selection method, and a non-transitory computer-readable recording medium storing a computer program that are capable of accurately ascertaining a field condition at low cost.

### Solution to Problem

In order for the above problem to be solved, a selection apparatus in the present disclosure, in an aspect thereof, includes at least:
an acquisition unit for acquiring field condition information that indicates respective field conditions related to crop cultivation at a plurality of points in a field subject to survey;
a selection unit for selecting, with use of information regarding the field conditions that are obtained from the field condition information acquired, a plurality of points that satisfy a point selection requirement which is given to the field subject to survey in advance;
a determination unit for determining, from among the plurality of points selected, sampling points at which a sampling survey is actually conducted; and
an output unit for outputting selection information and determination information, the selection information indicating selected points which are appropriate for sampling, the determination information indicating the sampling points at which the sampling survey is actually conduct, and
the selection unit is configured to use, as the field condition information acquired, at least one selected from the group consisting of an NDRE and an EVI to select the sampling points.

A selection method in the present disclosure is, in an aspect thereof,
a selection method which is carried out by a computer, and the selection method includes:
acquiring field condition information that indicates respective field conditions related to crop cultivation at a plurality of points in a field subject to survey;
selecting, with use of the field condition information acquired, a plurality of points that satisfy a point selection requirement which is given to the field subject to survey in advance;
determining, from among the plurality of points selected, sampling points at which a sampling survey is actually conducted; and
outputting selection information and determination information, the selection information indicating selected points which are appropriate for sampling, the determination information indicating the sampling points at which the sampling survey is actually conducted, and
in selecting the points which are appropriate for sampling, at least one selected from the group consisting of an NDRE and an EVI is selected as the field condition information acquired.

A non-transitory computer-readable recording medium storing the computer program in the present disclosure is, in an aspect thereof, a non-transitory computer-readable recording medium storing a computer program for causing
a computer to carry out:
a process of acquiring field condition information that indicates respective field conditions related to crop cultivation at a plurality of points in a field subject to survey;
a process of selecting, with use of information regarding the field conditions that are obtained from the field condition information acquired, a plurality of points that satisfy a field condition which is given to the field subject to survey in advance;
a process of determining, from among the plurality of points selected, sampling points at which a sampling survey is actually conducted; and
a process of outputting selection information and determination information, the selection information indicating selected points which are appropriate for sampling, the determination information indicating the sampling points at which the sampling survey is actually conducted,
in selecting the points which are appropriate for sampling, at least one selected from the group consisting of an NDRE and an EVI is selected as the field condition information acquired.

### ADVANTAGEOUS EFFECTS OF INVENTION

With the present disclosure, it is possible to accurately ascertain a field condition at low cost.

### BRIEF DESCRIPTION OF THE FIGURES

FIG. 1 is a diagram explaining an example configuration of a selection apparatus in accordance with the present disclosure.

FIG. 2 is a diagram visually illustrating an example of field condition information.

FIG. 3 is a diagram explaining the configuration of a selection unit.

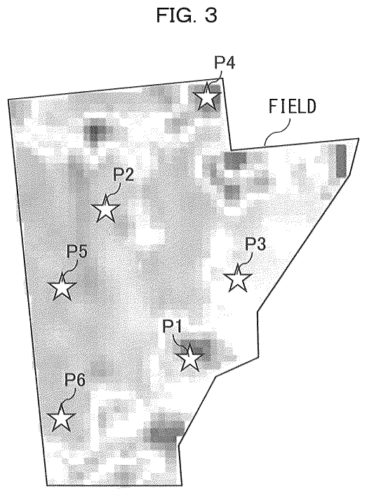

FIG. 4 is a diagram illustrating an example display in which selection information and determination information are displayed and which is produced on a display device.

FIG. 5 is a flowchart explaining an example operation of a selection apparatus which has the configuration illustrated in FIG. 1.

### DETAILED DESCRIPTION

The following description will discuss an embodiment of the present disclosure with reference to the drawings.

### Embodiment 1

A selection apparatus in accordance with Embodiment 1 of the present disclosure is a computer apparatus, and has the function of selecting locations (hereinafter referred to as “sampling points”) at which a survey in a field subject to survey is conducted. The survey in a field here is the survey for examining the cultivation status of a crop grown in the field. Actually, the survey is not conducted across the entire field, but the cultivation statuses of the crop are surveyed at the sampling points in the field (hereinafter, such a survey conducted at selected partial regions is referred to as sampling survey). The result of the sampling survey is used for estimating the cultivation status of the crop in the entire field.

The cultivation status of a crop can include various statuses related to the cultivation of the crop. Specific examples of the cultivation status include the growth status of the crop, the status of soil in which the crop is planted and the status of drainage of the soil, the growth status of the crop in relation to the amount of fertilizer applied, and information on land elevation differences. The details of the survey conducted as the survey of the cultivation status of a crop may be determined as appropriate by field operators or the like, according to the purpose of the survey. Such details of the survey are not limited here, and description thereof are therefore omitted. The purpose of the survey is an application in which the result of the survey of the cultivation status of a crop in a field is used. Examples of the purpose of the survey include estimation of a crop yield in the field, estimation of a harvest time, calculation of the amount of fertilizer to be applied, determination of the positions at which sensors and cameras for acquiring field conditions are installed, and soil improvement. A method for surveying the cultivation status of a crop is in accordance with the details of the survey. Such a method is not limited here, and the description thereof is therefore omitted.

In the description in Embodiment 1, the cultivation status of a crop is the growth status of a crop, for ease of description. The details of the survey of the cultivation status (growth status) of a crop are conditions of the crop related to harvest, including the color of leaves and the arrangement of leaves of the crop, and the number and the weight of fruits, roots, and rhizomes to be harvested. A method for surveying the cultivation status of a crop is such that a field operator actually observes the crop at the field, and captures an image of the crop via a camera to survey the color of leaves, the arrangement of leaves, and the number of fruits (seeds) to be harvested. A result of such a survey of the cultivation status of the crop is used in the process of estimating a crop yield and the process of predicting a harvest time. In other words, the purpose of the survey is to acquire information which pertains to the cultivation status of a crop and which is used in the process of estimating a crop yield or the process of predicting a harvest time.

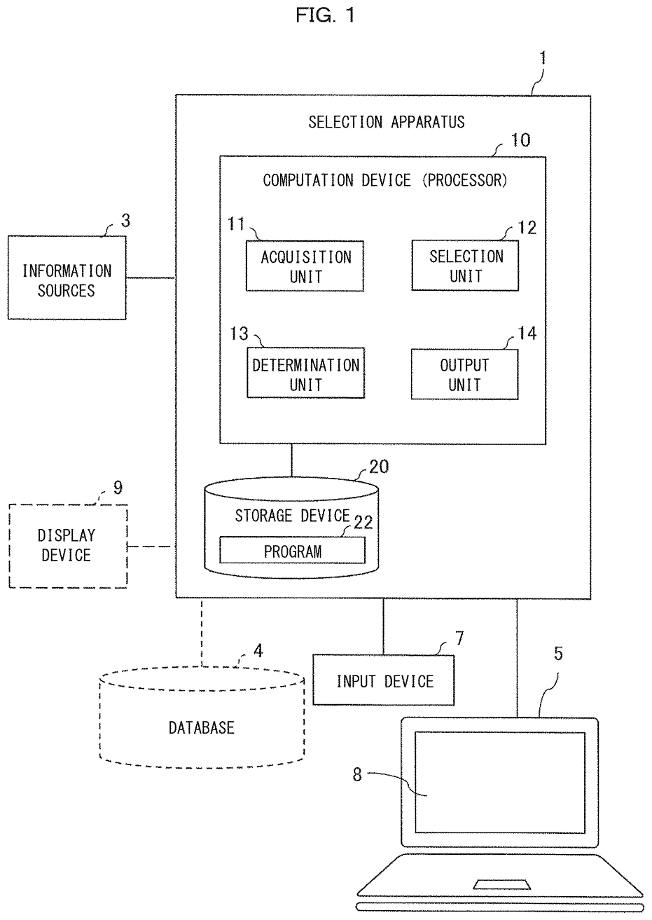

In Embodiment 1, a selection apparatus 1 is a server device, and is connected to information sources 3 and a terminal device 5 via an information and communication network, as illustrated in FIG. 1. The selection apparatus 1 is also connected to an input device 7. Further, the selection apparatus 1 is connected to a database 4 as needed. The input device 7 is a device via which an operator (hereinafter, also referred to as a device operator) of the selection apparatus 1 inputs information to the selection apparatus 1. The input device 7 is composed of a keyboard, a mouse, etc. The database 4 is a storage device. In the database 4, information retrieved from the information sources 3, information inputted via the input device 7, data calculated by the selection apparatus 1, or the like is stored as needed.

The information sources 3 provide the selection apparatus 1 with information. In Embodiment 1, one instance of the information sources 3 is an information source that outputs a satellite image of the field subject to survey. The satellite image of the field is a captured image which shows the field and which is captured via an onboard imaging device of an artificial satellite. In Embodiment 1, used as the field condition information indicating a field condition related to the cultivation of a crop are vegetation indexes such as a normalized difference vegetation index (NDVI), a ratio vegetation index (RVI), a difference vegetation index (DVI), a normalized difference red edge index (NDRE), and an enhanced vegetation index (EVI). As the field condition information, vegetation indexes such as a green normalized difference vegetation index (GNDVI) and a modified chlorophyll absorption ratio index (MCARI) may be used. It is preferable to use, as the field condition information, at least one vegetation index selected from the group consisting of an NDRE and an EVI. These vegetation indexes are obtained by quantifying the growth status (vegetation status) of a crop on the basis of the captured image of the crop, with use of the light reflection characteristics of the crop. For example, the formula for calculating the NDRE is Formula (1) below.

$$NDRE = ( NIR - Red Edge ) / ( NIR + Red Edge ) \qquad Formula ( 1 )$$

In Formula (1), NIR represents the reflectance in the near-infrared region that is acquired from a captured image, and Red Edge represents the reflectance in the red edge (a specific red wavelength region) acquired from the captured image. The NDRE is the vegetation index used for evaluating the health status of a plant and the nitrogen content, and is excellent for monitoring a plant which is more mature than indicated by the normalized difference vegetation index (NDVI) and vegetation which has high leaf area index.

In Embodiment 1, the vegetation index utilizing the light reflection characteristics of a crop is used. Thus, the satellite image of a field outputted by one of the information sources 3 contains information regarding light with a wavelength used for the calculation of the vegetation index.

The terminal device 5 is a computer apparatus operated by a user who is a field operator (such as a manager of the field subject to survey or a cultivator of a crop). The terminal device 5 has a communication function, and a display control function for controlling a display device 8 so that information is displayed. The type of terminal device 5 is not limited provided that the terminal device 5 is information equipment that has a communication function and a display control function. Specific examples of the terminal device 5 include personal computers, tablets, and smartphones. When the terminal device 5 is a smartphone or a tablet, the display device 8 is integral with the terminal device 5. When the terminal device 5 is a personal computer, the display device 8 can be external. The connection between the terminal device 5 and the selection apparatus 1 is implemented via an application program for providing the terminal device 5 with the function of cooperating with the selection device 1. Alternatively, the connection between the terminal device 5 and the selection apparatus 1 may be implemented via a browser (software for browsing information on the Internet). Whether the connection between the terminal device 5 and the selection apparatus 1 is implemented via an application program or via a browser is set as appropriate by a system designer, and is not limited here. Furthermore, although a single terminal device 5 is connected to the selection apparatus 1 in the example illustrated in FIG. 1, the selection apparatus 1 can be connected to a plurality of terminal devices 5.

The selection apparatus 1 is a computer apparatus, and includes a computation device 10 and a storage device 20. The storage device 20 has a storage medium for storing data and a computer program (hereinafter, referred to as a program) 22. There are various types of storage devices 20, and the selection apparatus 1 can be provided with multiple types of storage devices 20. The types and the number of storage devices to be provided in the selection apparatus 1 are not limited, and the descriptions thereof are omitted here.

The computation device 10 is composed of processors such as a central processing unit (CPU) and a graphics processing unit (GPU). By retrieving the program 22 stored in the storage device 20 to execute the program 22, it is possible for the computation device 10 to have various functions based on the program 22. In Embodiment 1, the computation device 10 has the functional units for selecting sampling points in the field, namely an acquisition unit 11, a selection unit 12, a determination unit 13, and an output unit 14, as illustrated in FIG. 1.

The acquisition unit 11 acquires field condition information. The field condition information indicates a field condition related to the cultivation of a crop in a field subject to survey. In the field condition information, position information indicating the position of each of a plurality of points in the field subject to survey is associated with information indicating the field condition at that point.

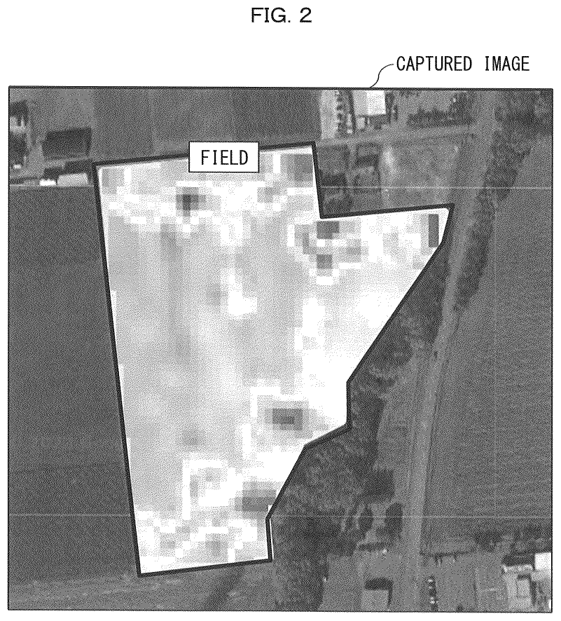

As described above, used as the field condition information in Embodiment 1 is a vegetation index such as the NDRE that is calculated on the basis of a satellite image of the field. That is, in Embodiment 1, the acquisition unit 11 acquires a satellite image of the field from the information sources 3. The acquisition unit 11 calculates the vegetation index from the acquired satellite image of the field, and thereby acquires the field condition information. FIG. 2 is an example representation of the image in which information visually indicating the NDRE is superimposed on the field part of the captured image that shows the field. In FIG. 2, the magnitude of an NDRE is represented by color shades, and when the vegetation index is lower, the color is darker. A satellite image is associated with position information that indicates the position of a captured place. This enables the acquisition unit 11 to create, as the field condition information, information in which the position information that indicates the place shown in a satellite image is associated with the vegetation index information, such as the NDRE, calculated using the satellite image.

The field condition information acquired by the acquisition unit 11 may be of one type, although in Embodiment 1, the acquisition unit 11 acquires a plurality of mutually different types of vegetation indexes, such as the NDRE and the EVI. That is, in Embodiment 1, the acquisition unit 11 acquires a plurality of types of field condition information.

The timing at which the acquisition unit 11 carries out the process of acquiring the field condition information may be set as appropriate by a system designer or the like, in consideration of the timing at which information from the selection apparatus 1 is outputted. Examples of such a timing include the following timings. One example timing at which the acquisition unit 11 carries out the process is a timing triggered when a request for selection to request the selection of sampling points is inputted into the selection apparatus 1 through the input device 7 operated by the device operator or through the terminal device 5 operated by a field operator. When there are a plurality of fields subject to survey, information (e.g., field identification information) for identifying the field for which a request to select sampling points is made is associated with the request for selection.

Another example timing at which the acquisition unit 11 carries out the process is a timing which is calculated according to a predetermined calculation method and which is before the time for a sampling survey to be conducted, provided that the time of the sampling survey is determined in advance on the basis of the purpose of survey, etc. Examples of the calculation method include a method of calculating, as the timing at which the acquisition unit 11 carries out the process, a set time of the date derived by subtracting a set number of days (e.g., three days) from the date that represents the first day of the time of the sampling survey.

The selection unit 12 uses information (e.g., vegetation index information as illustrated in FIG. 2) regarding the field condition that is obtained from the field condition information acquired by the acquisition unit 11, to select a plurality of points that satisfy a point selection requirement which is given to the field subject to survey in advance. The point selection requirement is a requirement as to points which are selected as points appropriate for a sampling survey. The points appropriate for sampling survey are points that provide information useful for estimating the condition of the entire field with use of the results of the survey. For example, points at which the field conditions differ from each other in terms of relative merit are selected as the points appropriate for a sampling survey. For example, selected as the points appropriate for a sampling survey are the point having the highest vegetation index (the point having the best field condition), the point having the lowest vegetation index (the point having the worst field condition), and a point having an intermediate vegetation index (the point having an intermediate field condition). The number of the points may be set as appropriate by a system designer or a device operator, in consideration of matters related to crop cultivation, such as the size of the field, the type of crop being cultivated in the field, the type of soil, and topography. Examples of the timing at which the selection unit 12 starts the process include a timing triggered when the field condition information is acquired by the acquisition unit 11.

From among the plurality of points selected by the selection unit 12 in the field subject to survey, the determination unit 13 determines the sampling points at which the sampling survey is actually conducted. In the method for determining the sampling points, matters related to the convenience of workers and the conditions of the field site are preferably taken into consideration. For example, although points P1 to P6 are selected by the selection unit 12 and are appropriate for the sampling survey, P2, P4, and P6 are inferior in the conditions of the field site. The determination unit 13 therefore does not conduct the sampling survey at these three points (P2, P4, P6), and determines P1, P3, and P5 for the sampling points at which the sampling survey is conducted. The inferiority in the conditions of the field site refers to the matter that cannot be found from satellite images, such as insufficient water supply, poor growth due to dust stirred up by vehicles running nearby, or the presence of abundant weeds, for example.

Examples of the requirement used by the determination unit 13 to select the points include adopting, as the points appropriate for sampling, points exhibiting the mean, median, mode of the vegetation index, or indexes close to these values. The number of the points appropriate for sampling may be one, or may be more than one. The number of the points appropriate for sampling is not limited but is set as appropriate according to the point selection requirement, etc. The number of points appropriate for the sampling is preferably not less than 5 and not more than 20. Examples of the timing at which the determination unit 13 starts the process include a timing triggered when the points are selected by the selection unit 12. As the position information indicating the points appropriate for sampling, for example, position information in a satellite image is used.

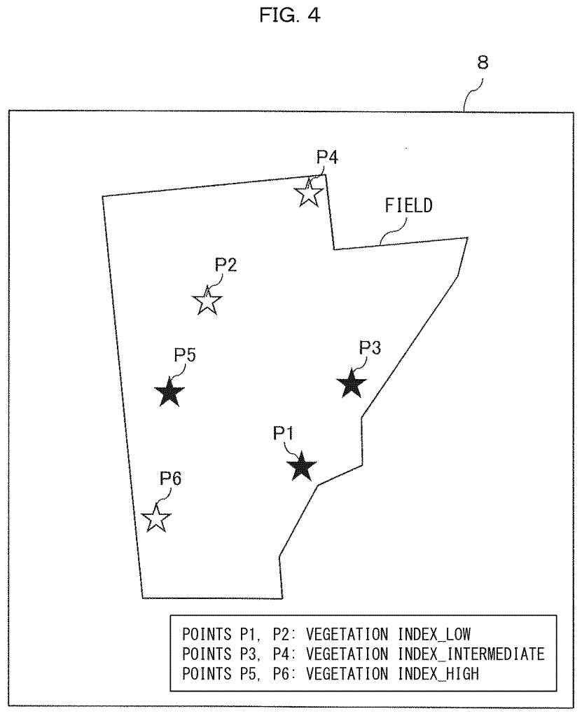

The output unit 14 outputs selection information indicating the points which are appropriate for sampling and determination information indicating the sampling points at which a sampling survey is actually conducted. For example, the acquisition unit 11, the selection unit 12, and the determination unit 13 sequentially carry out the processes in response to the reception of a request for selection from the terminal device 5, and sampling points are thereby determined. When the sampling points are determined, examples of the output destination of the selection information and the determination information include the terminal device 5, from which the request for selection is transmitted. In the terminal device 5, when the reception of the selection information and the determination information are received, the selection information indicating the points which are appropriate for sampling in the field subject to survey and the determination information indicating the sampling points at which the sampling survey is actually conducted are displayed on the display device 8. FIG. 4 is a representation of an example display that represents the points which are appropriate for sampling and the sampling points at which the sampling survey is actually conducted and that is produced on the display device 8. In the example of FIG. 4, lines, marks, and text that represent the positions of the points P1 to P6, which are appropriate for sampling, and the sampling points P1, P3, and P5, at which the sampling survey is actually conducted, are superimposed on a captured image that shows the field. Further, the points P1 to P6 appropriate for sampling are explained by text on the display device 8. On the captured image of the field displayed on the display device 8, information that visually indicates a vegetation index such as the NDRE may be superimposed.

Other examples of the output destination to which the output unit 14 outputs the selection information and the determination information include a display device 9 that is connected to the selection apparatus 1. When a device operator operates the input device 7 to input a request for selection to the selection apparatus 1, the acquisition unit 11, the selection unit 12, and the determination unit 13 sequentially carry out the processes in response to reception of the request for selection, and the points which are appropriate for sampling and the sampling points and sampling locations at which the sampling survey is actually conducted are determined accordingly. In this case, the output unit 14 outputs, to the display device 9, the selection information indicating the thereby selected points which are appropriate for sampling and the determination information indicating the determined sampling points at which the sampling survey is actually conducted. In other words, the output unit 14 controls the display on the display device 9 to display, on the display device 9, the selection information indicating the points which are appropriate for sampling and the determination information indicating the sampling points at which the sampling survey is actually conducted, as exemplified in FIG. 4.

The selection apparatus 1 in Embodiment 1 is configured as described above. The above-described pieces of information obtained by the respective processes carried out by the acquisition unit 11, the selection unit 12, and the determination unit 13 are stored in the storage device 20 and the database 4 so as to be in association with, for example, the field identification information for identifying the field subject to survey and time information which indicates the time (time of day) at which each of the processes was carried out.

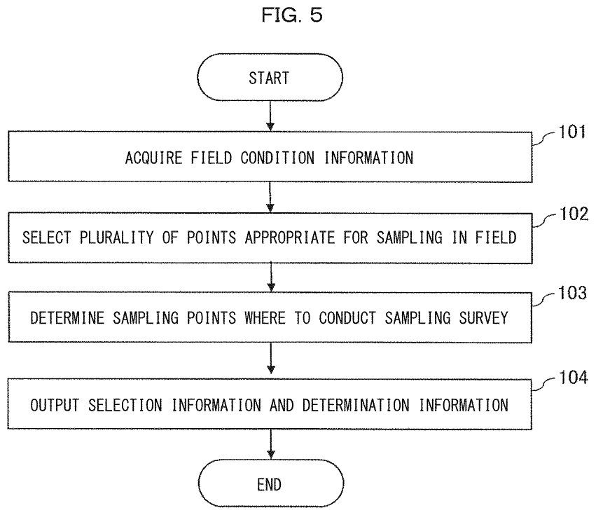

Next, with reference to FIG. 5, an example operation associated with the process of selecting the sampling points in the selection apparatus 1 in Embodiment 1 is described here. FIG. 5 is a flowchart illustrating a control procedure of the process of selecting the sampling points in the selection apparatus 1. FIG. 5 also indicates a selection method used by a computer included in the selection apparatus 1.

For example, first of all, in response to reception of a request for selection or a similar event, the acquisition unit 11 detects that it is the timing to carry out a process, and then acquires field condition information related to a field subject to survey (step 101). In Embodiment 1, the acquisition unit 11 first acquires a satellite image of the field subject to survey from the information sources 3. In the information sources 3, satellite images of the field subject to survey that are periodically captured are accumulated. Thus, from among the plurality of satellite images of the field subject to survey that are held in the information sources 3, the acquisition unit 11 acquires, for example, the most recently captured satellite image. The acquisition unit 11 then calculates a vegetation index on the basis of the acquired satellite image, to acquire field condition information that indicates the field condition through the vegetation index.

Thereafter, the selection unit 12 uses information regarding the field condition that is obtained by analyzing the field condition information acquired by the acquisition unit 11, to select a plurality of points (step 102).

Subsequently, the determination unit 13 determines, from among the plurality of points selected, sampling points at which a sampling survey is actually conducted (step 103).

The output unit 14 then outputs selection information indicating the selected points, which are appropriate for sampling, and determination information indicating the sampling points, at which the sampling survey is actually conducted (step 104). The pieces of information outputted from the selection apparatus 1 are displayed, for example, on the display device 8 at the output destination. For example, with reference to the selection information and the determination information (the points which are appropriate for sampling and the sampling points at which the sampling survey is actually conducted) that are displayed on the display device 8, a field operator conducts the sampling survey in the field subject to survey.

In the selection apparatus 1 in Embodiment 1, the selection unit 12 selects a plurality of points appropriate for sampling with use of field condition information, the determination unit 13 determines, from among the selected points, sampling points at which the sampling survey is actually conducted, and the output unit 14 outputs selection information indicating the selected points, which are appropriate for sampling, and determination information indicating the sampling points, at which a sampling survey is actually conducted. By conducting the sampling survey with reference to these pieces of output information, it is possible even for field operators with little experience to conduct an appropriate sampling survey that enables the ascertainment of the condition of the entire field.

Specifically, in the selection apparatus 1 in Embodiment 1, on the basis of the point selection requirement used in the selection unit 12, the output unit 14 can output the selection information that indicates the points appropriate for sampling, which are, for example, the point having the highest vegetation index, the point having the lowest vegetation index, and a point having an intermediate vegetation index, and the determination information that indicates sampling points at which the sampling survey is actually conducted.

By using these pieces of output information from the output unit 14, it is possible even for field operators with little experience to easily recognize a point where the crop growth is good, a point where the crop growth is intermediate, and a point where the crop growth is poor in the field subject to survey. By selecting such points that mutually differ in the crop growth status in the field to conduct the sampling survey, even field operators with little experience are expected to be able to ascertain the crop growth status in the entire field while suppressing increases in the burden of labor and cost. That is, it is possible even for field operators with little experience to accurately ascertain the field condition at low cost. By using the condition of the entire field that can be ascertained, it is also possible to increase the accuracies of, for example, crop yield estimation and harvest time prediction.

In the above-described example of Embodiment 1, a requirement of selecting, as the points appropriate for sampling, the point having the highest vegetation index, the point having the lowest vegetation index, and a point having an intermediate vegetation index is indicated as the point selection requirement used in the selection unit 12.

Instead, as the selection of the points appropriate for sampling, for example, the amount of fertilizer to be applied may be determined according to the condition of a point where the crop growth is intermediate in the field. In this case, the purpose of the survey is to survey the condition of the point where the crop growth is intermediate in order to determine the amount of fertilizer to be applied. In this case, in the selection apparatus 1, the selection unit 12 selects, as the points appropriate for sampling, points where the crop growth is intermediate. That is, the point selection requirement is such that the selection apparatus 1 selects, as the points appropriate for sampling, points having intermediate vegetation indexes. In such a case, it is possible for field operators to obtain, through the output from the selection .apparatus 1, information regarding the points which are appropriate for the sampling survey and at which the crop growth is intermediate, without requiring the field operators to spend labor and time actually observing the entire field to find points where crop growth is intermediate. In other words, the selection apparatus 1 outputs information on a field in order to determine the amount of fertilizer to be applied at a low cost, and it is possible for the field operators to accurately ascertain a field condition on the basis of the outputted information from the selection apparatus 1. Thus, the point selection requirement used in the selection apparatus 1 is determined according to the purpose of a sampling survey, and is not limited to the examples described in Embodiment 1.

Although the present disclosure has been described above with reference to an embodiment, the present disclosure is not limited to the above-described embodiment. To the configurations and details of the present disclosure, various modifications that could be understood by a person skilled in the art can be made within the scope of the present disclosure. Each embodiment can be combined, as appropriate, with another embodiment.

### REFERENCE SIGNS LIST

1: Selection apparatus
11: Acquisition unit
12: Selection unit
13: Determination unit
14: Output unit

1. A selection apparatus, comprising at least:
an acquisition unit for acquiring field condition information that indicates respective field conditions related to crop cultivation at a plurality of points in a field subject to survey;
a selection unit for selecting, with use of the field condition information acquired, a plurality of points that satisfy a point selection requirement which is given to the field subject to survey in advance;
a determination unit for determining, from among the plurality of points selected, sampling points at which a sampling survey is actually conducted; and
an output unit for outputting selection information and determination information, the selection information indicating selected points which are appropriate for sampling, the determination information indicating the sampling points at which the sampling survey is actually conducted, wherein
the selection unit is configured to use, as the field condition information acquired, at least one selected from the group consisting of an NDRE and an EVI to select the sampling points.

2. The selection apparatus according to claim 1, wherein
the number of points which are selected by the selection unit and which are appropriate for the sampling is not less than 5 and not more than 20.

3. The selection apparatus according to claim 1, wherein
at the plurality of points selected by the selection unit, the field conditions differ from each other in terms of relative merit, and
the point selection requirement is to include a point having the best field condition, a point having an intermediate field condition, and a point having the worst field condition.

4. A selection method carried out by a computer, the selection method comprising:
acquiring field condition information that indicates respective field conditions related to crop cultivation at a plurality of points in a field subject to survey;
selecting, with use of the field condition information acquired, a plurality of points that satisfy a point selection requirement which is given to the field subject to survey in advance;
determining, from among the plurality of points selected, sampling points at which a sampling survey is actually conducted; and
outputting selection information and determination information, the selection information indicating selected points which are appropriate for sampling, the determination information indicating the sampling points at which the sampling survey is actually conducted, wherein
in selecting the points which are appropriate for sampling, at least one selected from the group consisting of an NDRE and an EVI is selected as the field condition information acquired.

5. A non-transitory computer-readable recording medium storing a computer program for causing a computer to carry out:
a process of acquiring field condition information that indicates respective field conditions related to crop cultivation at a plurality of points in a field subject to survey;
a process of selecting, with use of the field condition information acquired, a plurality of points that satisfy a point selection requirement which is given to the field subject to survey in advance;
a process of determining, from among the plurality of points selected, sampling points at which a sampling survey is actually conducted; and
a process of outputting selection information and determination information, the selection information indicating selected points which are appropriate for sampling, the determination information indicating the sampling points at which the sampling survey is actually conducted, wherein
in selecting the points which are appropriate for sampling, at least one selected from the group consisting of an NDRE and an EVI is selected as the field condition information acquired.
